(19) United States
(12) Patent Application Publication
(10) Pub. No.: US 2012/0103216 A1
(43) Pub. Date: May 3, 2012

(54) MULTIPLE-LAYER FLAT STRUCTURE IN THE FORM OF A PRINTING BLANKET OR A PRINTING PLATE FOR FLEXOGRAPHIC AND LETTERPRESS PRINTING WITH LASER ENGRAVING

(76) Inventors: Clemens Knisel, Reinbek (DE); Stefan Füllgraf, Duderstadt (DE)

(21) Appl. No.: 13/278,468

(22) Filed: Oct. 21, 2011

Related U.S. Application Data
(63) Continuation of application No. PCT/EP2010/054168, filed on Mar. 30, 2010.

(30) Foreign Application Priority Data
Apr. 23, 2009 (DE) 10 2009 003 817.5

(51) Int. Cl. B41C 3/08

(52) U.S. Cl. 101/401.1

(57) ABSTRACT

The invention is directed to a multiple-layer flat structure (1) in the form of a printing blanket or a printing plate for flexographic and letterpress printing with: a printing layer (2) which is made from a polymeric material and is provided with laser engraving; at least one compressible layer (3); and, at least one strength-support layer (4); wherein the individual layers form an adhesive connection among one another. The multiple-layer flat structure (1) according to the invention is distinguished by the fact that the polymeric material of the printing layer (2) is a vulcanizate. Advantageous materials are proposed in this regard. The printing layer (2) expediently lies directly on a compressible layer (3). The compressible layer (3) is in turn in direct contact with a strength-support layer (4).

### CROSS REFERENCE TO RELATED APPLICATIONS

This application is a continuation application of international patent application PCT/EP 2010/054168, filed Mar. 30, 2010, designating the United States and claiming priority from German application 10 2009 003 817.5, filed Apr. 23, 2009, and the entire content of both applications is incorporated herein by reference.

### FIELD OF THE INVENTION

The invention relates to a multilayer sheet in the form of a printing blanket or of a printing plate for flexographic printing and letterpress printing with:
a printing layer made of a polymeric material and provided with laser engraving;
at least one compressible layer, and also
at least one reinforcement layer;
   where the individual layers form an interconnected adherent composite.

### BACKGROUND OF THE INVENTION

This type of sheet is disclosed by way of example in the following literature: U.S. Pat. No. 6,019,042; U.S. Pat. No. 6,935,236; EP 2 070 717 A1; WO 02/096648 A1; U.S. Pat. No. 5,798,202; and, U.S. Pat. No. 5,804,353; as well as Technik des Flexodruckes [Flexographic printing technology], p. 173 ff., 4th edition, 1999, Coating Verlag, St. Gallen (CH).

In the current prior art, in the context of flexographic and letterpress printing, the printing layer of the generic type of sheet with laser engraving is in most cases composed of a photopolymer. By way of example, the printing layer in U.S. Pat. No. 6,935,236 is composed of an elastomeric binder, of a polymerizable compound, of a photoinitiator or of a photoinitiator system, and also of a fine-particle filler, for example of a fumed oxide (silicon oxide, titanium oxide, aluminum oxide). The crosslinking of the entire area of the printing layer is achieved here via irradiation with light, for example with actinic light. Finally, a printing relief is engraved by means of a laser into the crosslinked printing layer. After the laser treatment, the printing layer is then also termed relief layer or printing plate.

However, a printing layer made of a photopolymer with laser engraving has the following attendant disadvantages:
Production of a printing plate involving a plurality of production steps is very laborious.
In most cases, it is necessary to readjust the contact pressure for printing at various speeds because of the dynamic rigidity of the material.
A feature of the photopolymeric printing layer or printing plate is low levels of ink transfer.
Mounting of the irradiated photopolymeric sheet can generate defects.
There are restrictions on the design in the form of roll product. In most cases, the end user has to have a variety of formats in inventory.

### SUMMARY OF THE INVENTION

A feature of the sheet of the invention with a view to eliminating the abovementioned disadvantages is that the polymeric material of the printing layer is a vulcanizate.

Vulcanizate is the term used for products or product components—in this case the printing layer—produced via vulcanization of a vulcanizable polymer mixture. The polymer mixture here comprises one or more rubber components. A vulcanizate is characterized by its elastic properties. Depending on the type of rubber used, crosslinking occurs using sulfur (e.g. in the case of NR) or peroxides (e.g. in the case of EPDM). A particularly important process is thermal vulcanization at temperatures of from 130 to 200° C. It is also possible to use cold vulcanization or radiation vulcanization.

For the vulcanizate, the following two variants are used in particular:

### Variant A

The vulcanizate is a vulcanized thermoplastic—free rubber mixture comprising at least one rubber component, and also mixing ingredients. Particular rubber components that may be mentioned are:

ethylene-propylene rubber (EPM)
ethylene-propylene-diene rubber (EPDM)
nitrile rubber (NBR)
(partially) hydrogenated nitrile rubber (HNBR)
fluororubber (FKM)
chloroprene rubber (CR)
natural rubber (NR)
styrene-butadiene rubber (SBR)
isoprene rubber (IR)
butyl rubber (IIR)
bromobutyl rubber (BIIR)
chlorobutyl rubber (CIIR)
butadiene rubber (BR)
chlorinated polyethylene (CM)
chlorosulfonated polyethylene (CSM)
polyepichlorohydrin (ECO)
ethylene-vinyl acetate rubber (EVA)
acrylate rubber (ACM)
ethylene-acrylate rubber (AEM)
silicone rubber (VMQ)
fluorinated methylsilicone rubber (MFQ)
perfluorinated propylene rubber (FFPM)
perfluorocarbon rubber (FFKM) polyurethane (PU)

The abovementioned types of rubber can be unblended. It is also possible to use a blend, in particular in conjunction with one of the abovementioned types of rubber, for example an NR/BR blend, or a BR/SBR blend.

The following are of particular importance: EPM, EPDM, SBR, BR, CR, NR, or NBR.

Typical mixing ingredients encompass at least one crosslinking agent or one crosslinking agent system (crosslinking agent and accelerator). Other mixing ingredients are typically a filler and/or a processing aid, and/or a plasticizer, and/or an antioxidant, and also optionally further additional materials (e.g. color pigments). Reference is made in this regard to the general prior art of rubber mixture technology.

### Variant B

The vulcanizate is a the thermoplastic vulcanizate comprising at least one thermoplastic component, at least one rubber component, which has been at least partially crosslinked, and also mixing ingredients.

The preferred thermoplastic components are polyethylene (PE), polypropylene (PP), polystyrene (PS), polyamide (PA) or polyester (PES).

Particular rubber components that may be mentioned are EPM, EPDM, SBR, BR, CR, NR or NBR, in particular in unblended form.

With respect to the mixing ingredients, reference is made to the abovementioned mixture technology, in particular to the teaching of U.S. Pat. No. 6,774,162.

In conjunction with the novel material for the printing layer, it is advantageous that the printing layer is in direct contact with a compressible layer, in contrast to a design in U.S. Pat. No. 6,019,042, in which the printing layer is in immediate contact with a reinforcement layer.

In a preferred layer structure, the compressible layer, which is in direct contact with the printing layer, is applied directly onto a reinforcement layer, so that the underlying structure is as follows, independently of the number of layers:
printing layer;
compressible layer;
reinforcement layer.

Based on this underlying structure there can be additional layers, in particular in terms of further compressible layers and reinforcement layers.

The compressible layer—also termed compression layer—serves for avoidance of flexing through volume reduction in the printing zone, and for compensation of impression differences. A decisive factor for the compressible layer is that it does not expand during compression, i.e., that its volume actually becomes smaller during compression, thus avoiding any lateral propagation of misalignment. By way of example, microbeads made from plastic can be used here in a rubber mixture, or a microporous cellular structure with gas inclusions can be used (foams). The relevant materials here are in particular polyurethanes, crosslinked polyethylenes, polypropylenes, NBR, neoprenes, and EPM. The modulus of elasticity is typically in the range from 1 MPa to 1000 MPa. With regard to further details relating to the compressible layer, reference is made to the literature cited in the introduction, in particular U.S. Pat. No. 6,019,042 and EP 2 070 717 A1.

The reinforcement layer used can comprise a textile structure, for example a woven material, or a foil, for example a polymer foil (e.g. polyamide foil) or metal foil. In the case of a sheet with many layers and at least two reinforcement layers, it is also possible to use a combination of a textile structure and a foil or a foil composite. By way of example, U.S. Pat. No. 6,019,042 describes a six-layer sheet with three woven layers and with a foil layer (polymer foil or metal foil).

The novel multilayer sheet in the form of a printing blanket or of a printing plate is delivered to customers in the form of roll product. The customer mounts the roll product onto a sleeve (adapter, printing cylinder) and then exposes the printing layer to a laser, with a subsequent cleaning process. By using modern laser technology, an engraved pattern using points with various depths and shapes within a grid can be introduced into the novel printing layer made of a vulcanizate. The engraved pattern is formed rapidly and cleanly, and without solvent. 100% registration accuracy and reproducibility is ensured here. A fact of great economic importance is that the process requires the customer to perform markedly fewer steps to produce the printing plate.

The multilayer sheet can also be supplied in the form of self-adhesive composite.

A comparative experiment and the results thereof are presented in the table below. In each case, the comparison relates to a three-layer printing plate with a layer sequence of printing layer, compressible layer, and reinforcement layer. The printing layer is composed in the first case, according to the prior art, of a photopolymer and in the second case, according to the invention, of a thermoplastic-free vulcanizate based on a peroxidically crosslinked EPDM. Test criteria in each case here are the most important technical printing data, namely the data for tonal value range, color intensity, and dynamic positional adjustment.

TABLE

| | Three-layer | Three-layer |
|---|---|---|
| | printing plate | printing plate |
| | with printing | with printing |
| | layer based on a | layer based on |
| Test criteria | photopolymer | EPDM |
| Tonal value range | + | +++ |
| Color intensity | + | +++ |
| Dynamic positional | + | +++ |
| adjustment | | |

The definitions relating to evaluation of the test criteria are:
+ standard
++ above standard
+++ well above standard

The following further comments relate to this comparative experiment and also to supplementary studies:
The novel printing layer made of a vulcanizate gives a significant improvement in printing performance.
In this connection, it is advantageous for the printing layer to be in direct contact with a compressible layer. The compressible layer in turn has direct contact with a reinforcement layer.
The best results are achieved with a thermoplastic-free vulcanizate based on EPM, EPDM, SBR, BR, CR, NR or NBR. The abovementioned rubber components can be unblended components or can form a blend, for example a BR/SBR blend.
The novel concept is in essence independent of the material of the compressible layer and of the reinforcement layer.
In terms of delivery in the form of roll products, it is possible to realize a wide variety of layer structures, and either of the following layer systems is an advantageous design variant: (a) a layer system wherein the multilayer sheet has three layers provided in the following layer sequence: printing layer; compressible layer; and reinforcement layer; and, (b) a layer system wherein the multilayer sheet has five layers provided in the following layer sequence: printing layer; first compressible layer; first reinforcement layer; second compressible layer; and second reinforcement layer. These layer systems will be described in somewhat greater detail in conjunction with the description of the figures.
Fewer steps are involved in the process of producing the printing plate from a printing layer, made from a vulcanizate and exposed to a laser, than is the case when photopolymers are used.

### BRIEF DESCRIPTION OF THE DRAWINGS

Inventive examples will now be used to illustrate the invention with reference to the drawings wherein:

FIG. 1 shows a cross section of a three-layer sheet with a printing layer made of a vulcanizate;

FIG. 2 shows a cross section of a five-layer sheet with a printing layer made of a vulcanizate; and,

FIG. 3 shows a plan view of a printing layer made of a vulcanizate with laser engraving.

### DESCRIPTION OF THE PREFERRED EMBODIMENTS OF THE INVENTION

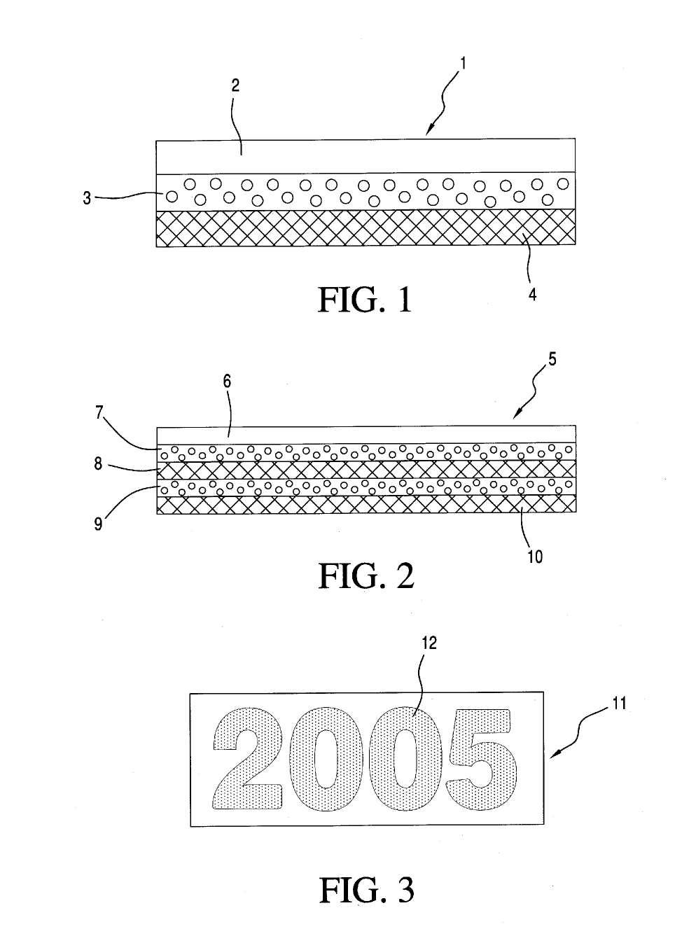

FIG. 1 shows a three-layer sheet 1 in the form of a printing blanket or of a printing plate with a printing layer 2 made of a vulcanizate, for example based on EPDM, where the printing layer is in direct contact with a compressible layer 3, for example in the form of microbeads made of plastic in a rubber mixture. The compressible layer then in turn has direct contact with a reinforcement layer 4, for example made of a woven material.

FIG. 2 shows a five-layer sheet 5 with the following layer sequence:
printing layer 6 made of a vulcanizate;
first compressible layer 7, for example in the form of microbeads made of plastic in a rubber mixture;
first reinforcement layer 8, for example made of a woven material;
second compressible layer 9, for example again in the form of microbeads made of plastic in a rubber mixture;
second reinforcement layer 10, for example again made of a woven material.

In the case of a sheet as in FIG. 2, it is also possible to use different reinforcement layers, for example where the first reinforcement layer is composed of a woven material and the second reinforcement layer is composed of a foil, for example of a polymer foil (e.g. polyamide foil), or of a metal foil, or of a foil composite, for example in the form of a polyamide-polyester foil composite.

The multilayer sheets in the inventive examples of FIG. 1 and FIG. 2 can be supplied in the form of roll products. The customer then carries out the required laser engraving accordingly.

FIG. 3 then shows a printing layer 11 with laser engraving 12, and specifically here in the form of the year 2005. Because the printing layer is a vulcanizate, when the printing plate is produced it is possible to produce an engraved pattern using dots with various depths and shapes in a grid.

It is understood that the foregoing description is that of the preferred embodiments of the invention and that various changes and modifications may be made thereto without departing from the spirit and scope of the invention as defined in the appended claims.

### KEY

### Part of Description

1 Multilayer sheet (printing blanket, printing plate)
2 Printing layer
3 Compressible layer
4 Reinforcement layer
5 Multilayer sheet (printing blanket, printing plate)
6 Printing layer
7 First compressible layer
8 First reinforcement layer
9 Second compressible layer
10 Second reinforcement layer
11 Printing layer
12 Laser engraving

What is claimed is:

1. A multilayer sheet in the form of a printing blanket or of a printing plate for flexographic printing and letterpress printing comprising:
a printing layer made of a polymeric material and providable with laser engraving;
at least one compressible layer, and
at least one reinforcement layer;
wherein the printing layer, the at least one compressible layer, and the at least one reinforcement layer form an adherent composite, and wherein the polymeric material of the printing layer is a vulcanizate.

2. The multilayer sheet as claimed in claim 1, wherein the vulcanizate is a vulcanized thermoplastic-free rubber mixture comprising at least one rubber component, and also mixing ingredients.

3. The multilayer sheet as claimed in claim 2, wherein the rubber component is selected from the group consisting of ethylene-propylene rubber (EPM), ethylene-propylene-diene rubber (EPDM), nitrile rubber (NBR), (partially) hydrogenated nitrile rubber (HNBR), fluororubber (FKM), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), butadiene rubber (BR), chlorinated polyethylene (CM), chlorosulfonated polyethylene (CSM), polyepichlorohydrin (ECO), ethylene-vinyl acetate rubber (EVA), acrylate rubber (ACM), ethylene-acrylate rubber (AEM), silicone rubber (VMQ), fluorinated methylsilicone rubber (MFQ), perfluorinated propylene rubber (FFPM), perfluorocarbon rubber (FFKM), and polyurethane (PU),
wherein the rubber component is provided unblended or in a blend.

4. The multilayer sheet as claimed in claim 3, wherein the rubber component is selected from the group consisting of EPM, EPDM, SBR, BR, CR, NR, and NBR.

5. The multilayer sheet as claimed in claim 1, wherein the vulcanizate is a thermoplastic vulcanizate comprising at least one thermoplastic component, at least one rubber component, which has been at least partially crosslinked, and also mixing ingredients.

6. The multilayer sheet as claimed in claim 5, wherein the thermoplastic component is selected from the group consisting of polyethylene (PE), polypropylene (PP), polystyrene (PS), polyamide (PA), and polyester (PES).

7. The multilayer sheet as claimed in claim 5, wherein the rubber component is selected from the group consisting of EPM, EPDM, SBR, BR, CR, NR, and NBR.

8. The multilayer sheet as claimed in claim 1, wherein the printing layer is in direct contact with a compressible layer.

9. The multilayer sheet as claimed in claim 8, wherein the compressible layer which is in direct contact with the printing layer is in direct contact with a reinforcement layer.

10. The multilayer sheet as claimed in claim 9, wherein the multilayer sheet has three layers being provided in the following layer sequence:
printing layer;
compressible layer; and
reinforcement layer.

11. The multilayer sheet as claimed in claim 1, wherein the multilayer sheet has at least four layers.

12. The multilayer sheet as claimed in claim 11, wherein the multilayer sheet has five layers being provided in the following layer sequence:
printing layer;
first compressible layer;
first reinforcement layer;
second compressible layer; and
second reinforcement layer.

13. The multilayer sheet as claimed in claim 3, wherein the blend comprises two or more rubber components selected from the group consisting of ethylene-propylene rubber (EPM), ethylene-propylene-diene rubber (EPDM), nitrile rubber (NBR), (partially) hydrogenated nitrile rubber (HNBR), fluororubber (FKM), chloroprene rubber (CR), natural rubber (NR), styrene-butadiene rubber (SBR), isoprene rubber (IR), butyl rubber (IIR), bromobutyl rubber (BIIR), chlorobutyl rubber (CIIR), butadiene rubber (BR), chlorinated polyethylene (CM), chlorosulfonated polyethylene (CSM), polyepichlorohydrin (ECO), ethylene-vinyl acetate rubber (EVA), acrylate rubber (ACM), ethylene-acrylate rubber (AEM), silicone rubber (VMQ), fluorinated methylsilicone rubber (MFQ), perfluorinated propylene rubber (FFPM), perfluorocarbon rubber (FFKM), and polyurethane (PU).

14. The multilayer sheet as claimed in claim 1, wherein the printing layer is provided with laser engraving.
